(19) United States
(12) Patent Application Publication
(10) Pub. No.: US 2024/0270052 A1
(43) Pub. Date: Aug. 15, 2024

(54) COOLING SYSTEM FOR TEMPERATURE CONTROL OF A PASSENGER CABIN

(71) Applicant: Robert Bosch GmbH, Stuttgart (DE)

(72) Inventors: Frank Heber, Achstetten (DE); Oliver Tschismar, Metzingen (DE)

(21) Appl. No.: 18/440,300

(22) Filed: Feb. 13, 2024

(30) Foreign Application Priority Data
Feb. 14, 2023 (DE) 10 2023 201 234.0
Feb. 1, 2024 (DE) 10 2024 200 918.0

(51) Int. Cl. B60H 1/32; B60H 1/00; B60H 1/14

(52) U.S. Cl. CPC B60H 1/32284; B60H 1/00278; B60H 1/143; B60H 2001/00307

(57) ABSTRACT

A cooling system for a vehicle includes a first cooling circuit for cooling a passenger cabin, a second cooling circuit for heating the passenger cabin, a third cooling circuit for controlling a temperature of a battery unit and/or a drive unit of the vehicle, and a refrigeration circuit with at least one condenser unit, an evaporator unit, an expansion unit and a compressor unit. The refrigeration circuit is thermally connected to the first cooling circuit, the second cooling circuit and the third cooling circuit via the condenser unit and/or the evaporator unit.

### BACKGROUND

The invention relates to a cooling system for controlling the temperature of a passenger cabin, in particular of a vehicle. The invention also relates to a method for controlling the temperature of a passenger cabin.

Cooling systems of various designs are known from the prior art.

It is a task of the invention to provide an improved cooling system for temperature control of a passenger cabin and an improved method for temperature control of a passenger cabin.

### SUMMARY

According to one aspect of the invention, there is provided a cooling system for a vehicle, comprising:
a first cooling circuit for cooling a passenger cabin;
a second cooling circuit for heating the passenger cabin of the vehicle;
a third cooling circuit for controlling the temperature of a battery unit and/or a drive unit of the vehicle; and
a refrigeration circuit with at least one condenser unit, an evaporator unit, an expansion unit and a compressor unit, wherein the refrigeration circuit is thermally connected to the first cooling circuit, the second cooling circuit and the third cooling circuit via the condenser unit and/or the evaporator unit.

This has the technical advantage that an improved cooling system can be provided for a vehicle. The cooling system comprises first and second cooling circuits, which are used to control the temperature of a passenger cabin of the vehicle, a third cooling circuit, which is used to control the temperature of a battery unit or a drive unit of the vehicle, and a refrigeration circuit, which is thermally connected to both the first and second cooling circuits of the passenger cabin and the third cooling circuit of the drive train. The refrigeration circuit, which comprises a condenser unit, an evaporator unit, an expansion unit and a compressor unit, can reduce the complexity of the cooling circuits for controlling the temperature in the passenger cabin. By designing the first and second cooling circuits separately from each other and using the first circuit to cool the passenger cabin while the second circuit is used to heat the passenger cabin, the individual first and second circuits can be designed as simply as possible. The cooling circuits are also filled with a coolant, such as water, which eliminates the need for a large number of highly complex refrigeration circuit components. This further simplifies the first and second cooling circuits and thus ensures a technically much simpler and more cost-effective cooling system.

The cooling system can be used in a vehicle, in particular an electrically powered vehicle.

According to one embodiment, the first cooling circuit comprises at least a first heat exchanger unit and a first pump unit and is thermally connected to the evaporator of the refrigeration circuit.

This has the technical advantage that the first heat exchanger unit can provide a cooling capacity for cooling the passenger cabin. The first pump unit can be used to activate or deactivate the first cooling circuit. A cooling mode of the passenger cabin can be activated, while deactivating a cooling function of the passenger cabin is prevented.

According to one embodiment, the second cooling circuit comprises at least a second heat exchanger unit and a second pump unit and is thermally connected to the condenser unit of the refrigeration circuit.

This has the technical advantage that the second heat exchanger unit can provide a heating output for heating the passenger cabin. The second pump unit can be used to activate or deactivate the second cooling circuit. The heating mode of the passenger cabin can be switched on by activating it and switched off by deactivating it.

According to one embodiment, the first and second cooling circuits can be activated and/or deactivated and/or controlled, in particular the flow rate can be regulated, by controlling, in particular switching, the first and second valve units, wherein a heating mode and/or a cooling mode and/or a dehumidification mode of the passenger cabin can be activated by activating and/or deactivating the first and second cooling circuits.

This has the technical advantage that different temperature control modes for the passenger cabin can be achieved by controlling, in particular activating or deactivating, the first and second cooling circuits. Preferably, the amount of flow through the cooling circuits, in particular the coolant flow, can be controlled, in particular regulated.

According to one embodiment, an eight-way valve and/or the drive unit and/or a battery unit and/or a drive heat exchanger unit are integrated into the third cooling circuit, wherein the drive unit and/or the battery unit and/or the drive heat exchanger unit can be thermally coupled to the refrigeration circuit as heat sources and/or heat sinks by switching the eight-way valve.

This has the technical advantage that by switching the eight-way valve and coupling various components of the third cooling circuit to the refrigeration circuit as heat sources or heat sinks, the various modes already mentioned can be used to control the temperature of the passenger cabin for different ambient temperatures. Depending on the ambient temperature, the various components can be thermally coupled to the refrigeration circuit as a heat source or heat sink in order to operate the refrigeration circuit with optimum efficiency and thus achieve the desired temperature control modes for the passenger cabin.

According to one embodiment, a first three-way valve is arranged in the third refrigeration circuit between the eight-way valve and the evaporator unit of the refrigeration circuit.

This can achieve the technical advantage that a thermal coupling of various components of the third cooling circuit to the evaporator unit of the refrigeration circuit can be effected or prevented by controlling the first three-way valve. Depending on the ambient temperature and the desired temperature control mode of the passenger cabin, the various components can be connected to the refrigeration circuit as heat sources or heat sinks. In particular, the first three-way valve can be designed as a proportional valve. As a proportional valve, the first three-way valve can be controlled accordingly. A proportional valve is used in particular to control a volume flow. The proportional valve makes it possible to regulate and thus control the volume flow, in particular the coolant flow.

According to one embodiment, a second three-way valve is arranged in the second cooling circuit between the eight-way valve and the condenser unit of the refrigeration circuit.

This, in turn, has the technical advantage that various components of the third cooling circuit can be thermally coupled to the condenser unit of the refrigeration circuit as heat sources or heat sinks via the switching/control of the second three-way valve, depending on the application and ambient temperature. This enables the refrigeration circuit to be operated with optimized efficiency. In particular, the second three-way valve can be designed as a proportional valve. As a proportional valve, the second three-way valve can be controlled accordingly.

According to one embodiment, the eight-way valve, the first three-way valve and the second three-way valve are realized integrally in a ten-way valve.

This has the technical advantage that the ten-way valve can be used to achieve the functionalities of the first and second three-way valves and the eight-way valve described above in a compact design.

According to one embodiment, a third pump unit is arranged in the third cooling circuit upstream of the first three-way valve between the eight-way valve and the first three-way valve, wherein a fourth pump unit is arranged in the third cooling circuit downstream of the eight-way valve between the eight-way valve and the drive unit.

This has the technical advantage that various components of the third cooling circuit can be thermally coupled to the cooling circuit as heat sinks or heat sources via the third pump unit within the third refrigeration circuit. Depending on the switching of the eight-way valve, different components of the third refrigeration circuit can be thermally coupled to the refrigeration circuit by activating or deactivating the third pump unit. This in turn can be used to control the temperature of the respective components of the third cooling circuit.

According to one embodiment, a fourth pump unit is arranged in the third cooling circuit downstream of the eight-way valve between the eight-way valve and the drive unit.

This has the technical advantage that the various components of the third cooling circuit can be thermally coupled to the cooling circuit as heat sinks or heat sources via the fourth pump unit within the third refrigeration circuit. Depending on the switching of the eight-way valve, different components of the third cooling circuit can be thermally coupled to the refrigeration circuit by activating or deactivating the fourth pump unit. This in turn can be used to control the temperature of the respective components of the third cooling circuit.

According to one embodiment, the refrigeration circuit is realized by a compact refrigeration system, wherein the condenser unit, the evaporator unit, the expansion unit and the compressor unit are installed on a base unit of the compact refrigeration system.

This has the technical advantage that the compact refrigeration system can provide a compact refrigeration circuit. This in turn can reduce the complexity of the cooling system and reduce the installation space of the cooling system.

According to one embodiment, there is a pipeless fluidic connection between the condenser unit and/or the evaporator unit and/or the expansion unit and/or the compressor unit of the compact refrigeration system .

The technical advantage of this is that a compact design of the refrigeration circuit can be achieved through the pipeless fluidic connection between the individual components of the refrigeration circuit. On the other hand, the material costs of the refrigeration circuit can be reduced by saving on coolant pipes. In addition, the compact design without additional refrigerant lines means that the amount of refrigerant required within the refrigeration circuit can be drastically reduced.

According to one embodiment, the refrigeration circuit is filled with a flammable refrigerant.

The technical advantage of this is that the flammable refrigerant, which has a GWP <150 and can be in the form of propane R290, for example, allows the refrigeration circuit to be operated with the highest possible efficiency.

According to one aspect, there is provided a method for tempering a passenger cabin and/or a drive unit and/or a battery unit of a vehicle via a cooling system according to one of the preceding embodiments, comprising: activating a cooling mode of the passenger cabin by switching the first pump unit and activating the first cooling circuit and activating the third cooling circuit while simultaneously deactivating the second cooling circuit; and/or activating a heating mode of the passenger cabin by switching the second pump unit and activating the second cooling circuit and activating the third cooling circuit while simultaneously deactivating the first cooling circuit; and/or activating a dehumidification mode of the passenger cabin by switching the first pump unit and activating the first cooling circuit and switching the second pump unit and activating the second cooling circuit.

Thereby, the technical advantage can be achieved that an improved method for tempering a passenger cabin and/or a drive unit and/or a battery unit of a vehicle can be provided, wherein the method uses the system for tempering with the technical advantages described above. The third cooling circuit can act as a heat source or heat sink for the refrigeration circuit as required. For this purpose, the third refrigeration circuit can be connected to the refrigeration circuit in such a way that excess energy can be discharged from the refrigeration circuit through the third cooling circuit or additional energy can be made available to the refrigeration circuit through the third cooling circuit.

According to one aspect, there is provided a ten-way valve for a cooling system for a vehicle according to one of the preceding embodiments.

Exemplary embodiments of the invention are explained with reference to the subsequent drawings.

### BRIEF DESCRIPTION OF THE DRAWINGS

The drawings show:

FIG. 1 a schematic representation of a cooling system for a vehicle according to one embodiment;

FIG. 2 another schematic representation of the cooling system for a vehicle according to a further embodiment;

FIG. 3 another schematic representation of the cooling system for a vehicle according to a further embodiment;

FIG. 4 a further schematic representation of the cooling system for a vehicle according to a further embodiment; and

FIG. 5 flow diagram of a process for temperature control of a passenger cabin and/or a drive unit and/or a battery unit of a vehicle.

### DETAILED DESCRIPTION

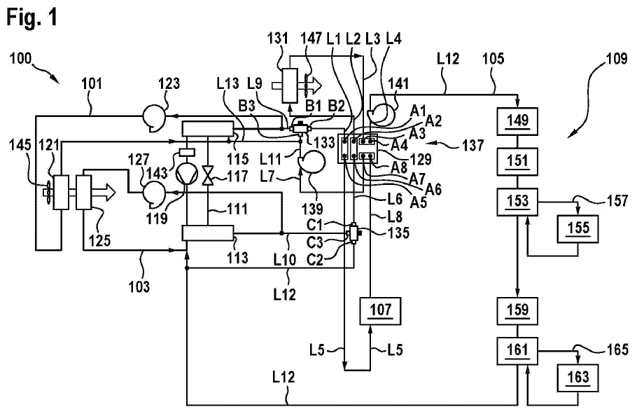

FIG. 1 shows a schematic representation of a cooling system for a vehicle according to one embodiment.

According to the invention, the cooling system 100 has a first cooling circuit 101 for cooling a passenger cabin, a second cooling circuit 103 for heating the passenger cabin, a third cooling circuit 105 for controlling the temperature of a battery unit 107 and/or a drive unit 109 and a refrigeration circuit 111 with a condenser unit 113, an evaporator unit 115, an expansion unit 117 and a compressor unit 119. The refrigeration circuit 111 is thermally coupled with the first cooling circuit 101, the second cooling circuit 103 and the third cooling circuit 105.

In the embodiment shown, the first refrigeration circuit 101 has a first heat exchanger unit 121 and a first pump unit 123 and is thermally connected to the evaporator unit 115 of the refrigeration circuit 111. The second cooling circuit 103 has a second heat exchanger unit 125 and a second pump unit 127 and is thermally connected to the condenser unit 113 of the refrigeration circuit 111.

In the embodiment shown, the first and second heat exchanger units 121, 125 of the first and second cooling circuits 101, 103 are combined in an air conditioning box of the vehicle cabin. A first fan unit 145 is also arranged on the air conditioning box. The first and second heat exchanger units 121, 125 can be used to control the temperature of the passenger cabin by cooling, heating or dehumidifying.

In the embodiment shown, the first pump unit 123 is arranged downstream of the evaporator unit 115 between the evaporator unit 115 and the first heat exchanger unit 121. Alternatively, the first pump unit 123 can also be arranged upstream of the evaporator unit 115 between the first heat exchanger unit 121 and the evaporator unit 115. The second pump unit 127 is arranged analogously downstream of the condenser unit 113 between the condenser unit 113 and the second heat exchanger unit 125 of the second cooling circuit. Alternatively, the second pump unit 127 can also be arranged upstream of the condenser unit between the second heat exchanger unit 125 and the condenser unit 113.

According to one embodiment, the drive unit 109 can have a plurality of components. The drive unit 109 can have a DC/DC on-board charger 149 and/or a first inverter 151 arranged downstream thereof and/or a first coolant/oil heat exchanger 153 arranged downstream thereof and/or a first drive 155. The first coolant/oil heat exchanger 153 and the first drive 155 can be arranged in a fourth cooling circuit 157. Downstream of this, a second inverter 159 and/or downstream of this, a second coolant/oil heat exchanger 161 and/or a second drive 163 can be arranged in the third cooling circuit 105. The second coolant/oil heat exchanger 161 and/or the second drive 163 can be arranged in a separate fifth cooling circuit 165.

Alternatively, the drive unit 109 can also comprise only one drive instead of the combination of second drive 163 and first drive 155. Accordingly, only one inverter and one coolant/oil heat exchanger are designed. If, for example, only the first drive is formed, then only the first inverter 151 and the first coolant/oil heat exchanger 153 are formed. Preferably, the first drive is rear-wheel drive 155. Preferably, the second drive is designed as a front-wheel drive 163.

The battery unit 107 is also positioned downstream of the drive unit 109 in the third cooling circuit 105.

In the embodiment shown, the third cooling circuit 105 also has an eight-way valve 129. The eight-way valve 129 is arranged downstream of the battery unit between the battery unit and the drive unit 109.

Furthermore, the third cooling circuit 105 has a drive heat exchanger unit 131 with a second fan unit 147. The drive heat exchanger unit 131 is arranged downstream of the eight-way valve 129. The drive heat exchanger unit 131 is coupled to the ambient air of the vehicle and can serve as a heat source or heat sink for the other components of the cooling system 100, depending on the ambient temperature.

In the embodiment shown, the third cooling circuit 105 further comprises a third pump unit 139. The third pump unit 139 is arranged downstream of the eight-way valve 129 between the eight-way valve 129 and the evaporator unit 115 of the refrigerant circuit 111. Via the third pump unit 139, coolant of the third refrigeration circuit 105 can be conveyed through the evaporator unit 115 of the refrigeration circuit 111 and via this, various components of the third refrigeration circuit 105 can be fluidically coupled to the refrigeration circuit 111 as heat sources or heat sinks.

In the embodiment shown, the third cooling circuit 105 further comprises a fourth pump unit 141 arranged downstream of the eight-way valve 129 and positioned between the eight-way valve 129 and the drive unit 109. Coolant from the third cooling circuit 105 can in turn be conveyed through the drive unit 109 via the fourth pump unit 141, thereby bringing about temperature control of the drive unit 109.

In the embodiment shown, the third cooling circuit 105 further comprises a first three-way valve 133. The first three-way valve 133 is positioned between the eight-way valve 129 and the evaporator unit 115 of the refrigeration circuit 111. Access to the evaporator unit for coolant of the third cooling circuit 105 can be opened or closed via the first three-way valve.

In the embodiment shown, the third cooling circuit 105 has a second three-way valve 135. The second three-way valve 135 is arranged between the eight-way valve 129 and the condenser unit 113.

In the embodiment shown, the refrigeration circuit 111 further comprises an accumulator unit 143. The accumulator unit 143 is arranged downstream of the evaporator unit 115 between the evaporator unit and the compressor unit 119. Alternatively, a liquid collector can be arranged downstream of the condenser unit 113 between the condenser unit 113 and the expansion unit 117.

According to one embodiment, the refrigeration circuit 111 is designed as a compact refrigeration system and the condenser unit 113, the evaporator unit 115, the expansion unit 117 and the compressor unit 119 are fixed to a common base unit. According to a further embodiment, there is a pipeless fluidic connection between the condenser unit 113 and/or the evaporator unit 115 and/or the expansion unit 117 and/or the compressor unit 119. The pipeless fluidic connection of the aforementioned components is realized via a fluidic connection that does not require additional refrigerant lines. The components mentioned are thus directly connected to each other via corresponding fluidic connection elements.

According to one embodiment, the refrigeration circuit 111 is filled with a flammable refrigerant, for example propane R290.

According to one embodiment, the first to third cooling circuits 101, 103, 105 are filled with a coolant, for example water or a mixture of water and glycol.

In the embodiment shown, the eight-way valve 129 has eight connections A1, A2, A3, A4, A5, A6, A7, A8. The first three-way valve 133 has three connections B1, B2, B3. The second three-way valve 135 also has three connections C1, C2, C3.

In the embodiment shown, the first three-way valve 133 is connected to the second connection B2 via a first line L1 to the first connection A1 of the eight-way valve 129. Furthermore, the first three-way valve 133 with the first connection B1 is connected to the evaporator unit 115 of the refrigeration circuit 111 via a ninth line L9. The third connection B3 connects the first three-way valve 133 to the third pump unit 139 via an eleventh line L11. Alternatively, the third pump unit 139 and/or the first three-way valve 133 can be integrated into the eight-way valve 129.

The second three-way valve 135 is connected to the first connection C1 via a sixth line L6 to the sixth connection A6 of the eight-way valve 129. With the second connection C2, the second three-way valve 135 is connected to the drive unit 109 via a twelfth line L12. With the third connection C3, the second three-way valve 135 is connected to the condenser unit 113 of the refrigeration circuit 111 via a tenth line L10.

If C2 of the second three-way valve 135 is closed and C3 is (partially) open, the coolant flows into the condenser unit 113 and via line L10 to the three-way valve 135. If C2 of the second three-way valve 135 is closed and C3 is (partially) open, the coolant flows via line L12 to the second three-way valve 135. Alternatively, C2 and/or C3 can be partially opened if the second three-way valve 135 is designed as a proportional valve. This results in a partial coolant flow via C2 and/or a partial coolant flow via C3. Depending on the position of the three-way valve, which is exemplarily designed as a proportional valve, one of the coolant flows and/or both and/or several coolant flows can be controlled, in particular regulated.

In the embodiment shown, the drive heat exchanger unit 131 is connected to the second connection A2 of the eight-way valve 129 via a second line L2 and to the third connection A3 of the eight-way valve 129 via a third line L3. The second three-way valve 135 can in turn be integrated into the eight-way valve 129.

The fourth pump unit 141 is connected to the fourth connection A4 of the eight-way valve 129 via a fourth line L4 and to the drive unit 109 via a twelfth line L12. The drive unit 109 is connected to the second connection C2 of the second three-way valve 135 via the twelfth line L12.

In the embodiment shown, the battery unit 107 is connected to the fifth connection A5 via a fifth line L5 and to the eighth connection A8 of the eight-way valve 129 via an eighth line L8.

In the embodiment shown, the third pump unit 139 is connected to the seventh port A7 of the eight-way valve 129 via a seventh line L7 and to the third port B3 of the first three-way valve 133 via the eleventh line L11.

The first and second pump units 123, 127 can be used to activate or deactivate the first and second cooling circuits 101, 103. By activating the first pump unit 123 and deactivating the second pump unit 127, which activates the first cooling circuit 101 and deactivates the second cooling circuit 103, a purely cooling function of the passenger cabin can be achieved. Conversely, by activating the second pump unit 127 and deactivating the first pump unit 123, whereby the first cooling circuit 101 is deactivated and the second cooling circuit 103 is activated, a pure heating function of the passenger cabin can be realized. By simultaneously activating the first and second pump units 123, 127 in a coordinated manner and thereby activating the first and second cooling circuits 101, 103, a dehumidification function of the passenger cabin can be achieved, in which a simultaneous cooling and heating capacity is provided. By activating or deactivating the first and second pump units 123, 127 accordingly, any heating or cooling functions of the passenger cabin can thus be realized.

The eight-way valve 129 can also be switched in various switching states. By switching the eight-way valve 129 and by activating or deactivating the third and fourth pump units 139, 141 and/or controlling the first and second three-way valves 133, 135, various components of the third cooling circuit 105 can be thermally coupled and/or controlled as heat sources or heat sinks to the refrigeration circuit 111.

In the embodiment shown, the first port A1 and the fifth port A5, the second port A2 and the sixth port A6, the third port A3 and the fourth port A4 and the seventh port A7 and the eighth port A8 of the eight-way valve 129 are fluidically connected to one another.

As a result, the battery unit 107 is connected via the seventh and eighth connections A7, A8 and the seventh and eighth lines L7, L8 to the third pump unit 139, which in turn is connected via the eleventh line L11 to the first three-way valve 133, which in turn is connected via the first line L1 to the eight-way valve 129, which in turn is connected via the fifth line L5 to the battery unit 107. By activating the third pump unit 139 and by correspondingly controlling or switching the first three-way valve 133, a thermal coupling of the battery unit with the evaporator unit 115 can be effected. Depending on the heating or cooling mode of the passenger cabin and depending on the ambient temperature or the battery temperature of the battery unit 107, the battery unit 107 can be coupled to the refrigeration circuit 111 as a heat source or heat sink.

The coolant runs from the eight-way valve 129 via the fifth line L5 through the battery unit 107, from here through the eighth line L8 via the eight-way valve 129 and via the seventh line L7 through the third pump unit 139 via the eleventh line L11 into the first three-way valve 133. From here, the coolant can be fed into the evaporator unit 115 via the ninth line L9, thereby creating a thermal coupling between the battery unit and the refrigeration circuit 111. Alternatively, the coolant can be controlled from the first three-way valve 133 via the first line L1 back into the eight-way valve 129 in order to decouple the battery unit 107 from the refrigerant circuit 111.

Via the connection of the second and sixth connections A2, A6 and the third and fourth connections A3, A4 of the eight-way valve 129, the drive heat exchanger unit 131 is connected via the second line L2 and the third line L3 to the eight-way valve 129, which in turn is connected via the fourth line L4 to the fourth pump unit 141, which in turn is connected via the twelfth line L12 to the drive unit 109, which in turn is connected via the twelfth line L12 to the second three-way valve 135, which in turn is connected via the sixth line L6 to the sixth connection A6 of the eight-way valve 129. By appropriately controlling or switching the fourth pump unit 141 and the second three-way valve 135, the drive unit 109 or the drive heat exchanger unit 131 can be thermally coupled to the condenser unit 113 of the refrigeration circuit 111 as heat sources or heat sinks.

The coolant of the third cooling circuit 105 runs via the second line L2 through the drive heat exchanger unit 131, through the third line L3 back into the eight-way valve 129, via the fourth line L4 through the fourth pump unit 141, via the twelfth line L12 through the drive unit 109 and from here via the twelfth line L12 into the second three-way valve 135. From here, the coolant can be fed via the tenth line L10 into the condenser unit 113 of the refrigeration circuit 111 in order to effect a thermal coupling with the refrigeration circuit 111, or via the sixth line L6 back into the eight-way valve 129 in order to decouple the drive unit 109 and the drive heat exchanger unit 131 from the refrigeration circuit 111.

In the circuit shown, the battery unit 107 can be individually thermally coupled with the evaporator unit 115. The drive heat exchanger unit 131 and the drive unit 109, on the other hand, are connected in series and can be thermally coupled with the condenser unit 113.

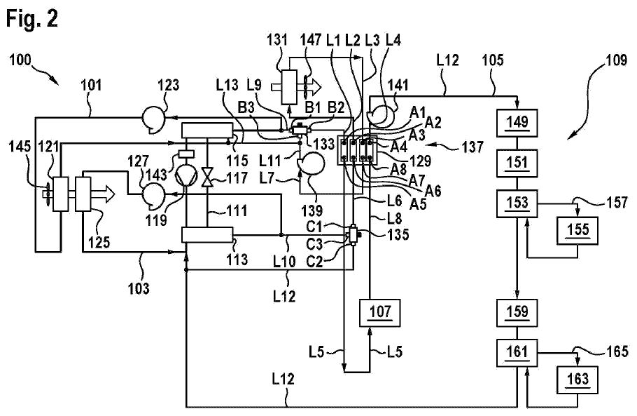

FIG. 2 shows a further schematic representation of the cooling system for a vehicle according to a further embodiment.

The embodiment in FIG. 2 is based on the embodiment in FIG. 1 and includes all the features described there. The embodiment shown differs from the embodiment in FIG. 1 in the switching of the eight-way valve 129.

In the circuit shown, the first port A1 and the fifth port A5, the second port A2 and the sixth port A6, the third port A3 and the seventh port A7 and the fourth port A4 and the eighth port A8 of the eight-way valve 129 are each fluidically connected to one another.

Here, the coolant of the third cooling circuit 105 runs via the second line L2 from the eight-way valve 129 through the drive heat exchanger unit 131, from here via the third line L3 through the eight-way valve 129 and via the seventh line L7 into the third pump unit 139, from here via the eleventh line L11 into the three-way valve 133, from here either via the ninth line L9 and the thirteenth line L13 through the evaporator unit 115 and/or via the third connection B3 of the first three-way valve 133 back into the eight-way valve 129. From here, the refrigerant runs via the fifth line L5 and the eighth line L8 through the battery unit 107 back into the eight-way valve 129, and from here via the fourth line L4 and the twelfth line L12 through the fourth pump unit 141 into the drive unit 109. The refrigerant runs from the drive unit 109 via the twelfth line L12 into the second three-way valve 135. From here, the refrigerant runs either via the tenth line L10 into the condenser unit 113 of the refrigerant circuit 111 or via the sixth line L6 back into the eight-way valve 129.

In the circuit shown, the battery unit 107, the drive unit 109 and the drive heat exchanger unit 131 are connected in series and can be thermally coupled to the condenser unit 113 and/or the evaporator unit 115 via corresponding switching of the first and second three-way valves 133, 135.

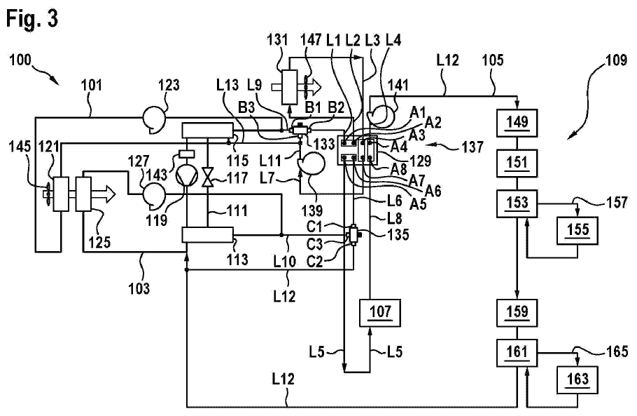

FIG. 3 shows a further schematic representation of the cooling system 100 for a vehicle according to a further embodiment.

The embodiment shown is based on the embodiments of FIGS. 1 and 2 and includes all the features described therein. The embodiment shown differs from the embodiments mentioned in the switching of the eight-way valve 129.

In the circuit shown, the first connection A1 and the second connection A2, the third connection A3 and the seventh connection A7, the fifth connection A5 and the sixth connection A6 and the fourth connection A4 and the eighth connection A8 are each fluidically connected to each other.

The coolant runs via the second line L2 from the eight-way valve 129 into the drive heat exchanger unit 131 and from here via the third line L3 back into the eight-way valve 129. From here, the coolant runs via the seventh line L7 into the third pump unit 139 and from here via the eleventh line L11 to the evaporator unit 115 and downstream to the first three-way valve 133. From here, the coolant can be fed through the evaporator unit 115 via the ninth line L9 and the thirteenth line L13. Via the first line L1, the coolant can be fed from the first three-way valve 133 back into the eight-way valve 129 and from here via the second line L2 back into the drive heat exchanger unit 131. If B1 of the first three-way valve 133 is closed and B3 is (partially) open, the coolant flows from the third pump unit 139 via the first three-way valve 133 to the connection A1 of the eight-way valve 129. If B3 of the first three-way valve 133 is closed and B1 is (partially) open, the coolant flows via the evaporator unit 115 and the first three-way valve 133 to the connection A1 of the eight-way valve 129. Alternatively, B1 and B3 can be partially opened if the first three-way valve 133 is designed as a proportional valve. This results in a partial coolant flow via B1 and/or a partial coolant flow via B3. The drive heat exchanger unit 131 can thus be thermally coupled to the refrigeration circuit 111 as a heat source or heat sink via the circuit of the first three-way valve 133.

Furthermore, the coolant runs from the eight-way valve 129 via the fourth line L4 and the twelfth line L12 through the fourth pump unit 141 into the drive unit 109. The refrigerant flows from the drive unit 109 via the twelfth line L12 into the second three-way valve 135. From here, the coolant can be fed into the evaporator unit 115 via the tenth line L10. Via the sixth line L6, the coolant can be fed from the second three-way valve 135 back into the eight-way valve 129 and from here via the fifth line L5 into the battery unit 107. From here, the coolant can be fed back into the eight-way valve 129 via the eighth line L8 and from here back through the fourth pump unit 141 via the fourth line L4. This allows the battery unit 107 and the drive unit 109 to be connected in series and thermally coupled to the refrigeration circuit 111 via the second three-way valve 135 as a heat source or heat sink via the condenser unit 113.

In the circuit shown, the drive heat exchanger unit 131 can be individually thermally coupled to the evaporator unit 115 by switching the first three-way valve 133. The battery unit 107 and the drive unit 109, on the other hand, are connected in series and can be thermally coupled to the condenser unit 113 via the second three-way valve 135.

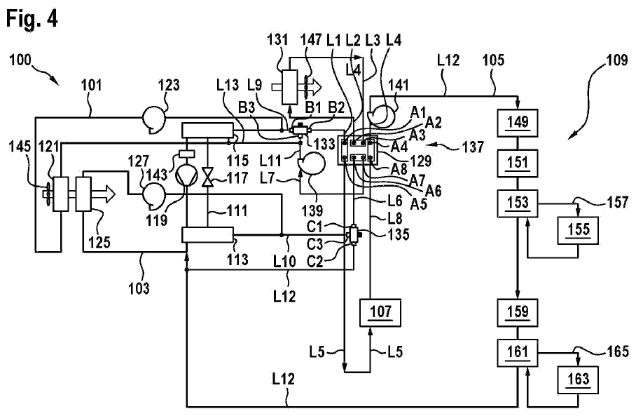

FIG. 4 shows a further schematic representation of the cooling system 100 for a vehicle according to a further embodiment.

The embodiment shown is based on the embodiments in FIGS. 1 through 3. The embodiment shown again differs from the embodiments mentioned only in the switching of the eight-way valve 129.

In the embodiment shown, the first connection A1 and the fifth connection A5, the second connection A2 and the third connection A3, the sixth connection A6 and the seventh connection A7 and the fourth connection A4 and the eighth connection A8 are fluidically connected to each other.

The coolant runs via the second line L2 from the eight-way valve 129 into the drive heat exchanger unit 131 and from here via the third line L3 back into the eight-way valve 129. The drive heat exchanger unit 131 is thus decoupled from the refrigeration circuit 111. The coolant also runs via the fourth line L4 from the eight-way valve 129 into the fourth pump unit 141 and from here via the twelfth line L12 through the drive unit 109 and into the second three-way valve 135. From here, the coolant can be fed into the condenser unit 113 via the tenth line L10 or back into the eight-way valve 129 via the sixth line L6. From here, the refrigerant can be fed via the seventh line L7 into the third pump unit 139 and from here via the eleventh line L11 into the first three-way valve 133. Via the ninth line L9 and the thirteenth line L13, the coolant can be fed from the first three-way valve 133 through the evaporator unit 115 or directly back into the first line L1 via the third connection B3 of the first three-way valve 133. Via the first line L1, the coolant can be fed from the first three-way valve 133 into the eight-way valve 129 and from here via the fifth line L5 into the battery unit 107. The coolant can be fed from the battery unit 107 via the eighth line L8 back into the eight-way valve 129 and from here via the fourth line L4 back into the fourth pump unit 141. In the circuit shown, the battery unit 107 and the drive unit 109 can thus be connected in series as heat sources or heat sinks via the circuit of the second three-way valve 135 and thermally coupled to the refrigeration circuit 111 via the condenser unit 113.

In the embodiments shown in FIGS. 1 through 4, the eight-way valve 129, the first three-way valve 133 and the second three-way valve 135 can be integrally combined in the form of a ten-way valve 137.

In the embodiments shown in FIGS. 1 through 4, various temperature control modes of the passenger cabin as well as cooling or heating functions of the battery unit 107 and the drive unit 109 can be effected by switching the eight-way valve 129 and/or controlling the first and second three-way valves 133, 135 and by activating or deactivating the first to fourth pump units 123, 127, 139, 141.

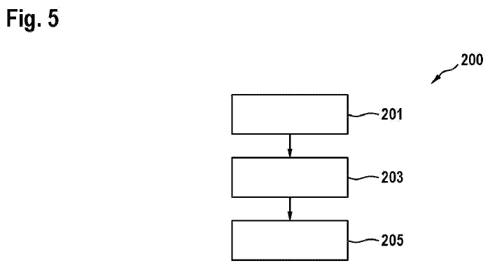

FIG. 5 shows a flow diagram of a method 200 for tempering a passenger cabin and/or a battery unit 107 and/or a drive unit 109 of a vehicle.

For temperature control of the passenger cabin and/or the battery unit 107 and/or the drive unit 109 of the vehicle via the cooling system 100 described above, a cooling mode of the passenger cabin can be effected in a first method step 201 by switching the first pump unit 123 and activating the first cooling circuit 101 while simultaneously deactivating the second cooling circuit 103.

Alternatively or additionally, in a further method step 203, a heating mode of the passenger cabin can be effected by switching the second pump unit 127 and activating the second cooling circuit 103 while simultaneously deactivating the first cooling circuit 101.

Alternatively or additionally, in a further method step 205, a dehumidification mode of the passenger cabin can be activated by switching the first pump unit 123 and activating the first cooling circuit 101 and switching the second pump unit 127 and activating the second cooling circuit 103.

The switching of the first and second pump units 123, 127 corresponds in the sense of the application to a switching on of the respective pump unit and causes an activation of the respective first or second cooling circuit 101, 103.

Temperatures between 0 and 10° C. can be reached in the first cooling circuit 101. Temperatures of up to 90° C. can be reached in the second cooling circuit 103.

1. A cooling system (100) for a vehicle, comprising:
a first cooling circuit (101) for cooling a passenger cabin;
a second cooling circuit (103) for heating the passenger cabin;
a third cooling circuit (105) for controlling a temperature of a battery unit (107) and/or a drive unit (109) of the vehicle; and
a refrigeration circuit (111) with at least one condenser unit (113), an evaporator unit (115), an expansion unit (117) and a compressor unit (119), wherein the refrigeration circuit (111) is thermally connected to the first cooling circuit (101), the second cooling circuit (103) and the third cooling circuit (105) via the condenser unit (113) and/or the evaporator unit (115).

2. The cooling system (100) according to claim 1, wherein the first cooling circuit (101) comprises at least a first heat exchange unit (121) and a first pump unit (123) and is thermally connected to the evaporator unit (115) of the refrigeration circuit (111).

3. The cooling system (100) according to claim 1, wherein the second cooling circuit (103) comprises at least a second heat exchange unit (125) and a second pump unit (127) and is thermally connected to the condenser unit (113) of the refrigeration circuit (111).

4. The cooling system (100) according to claim 3, wherein the first and second cooling circuits (101, 103) can be activated and/or deactivated by switching the first and second pump units (123, 127), and wherein a heating mode and/or a cooling mode and/or a dehumidification mode of the passenger cabin can be activated by controlling and/or activating and/or deactivating the first and second cooling circuits (101, 103).

5. The cooling system (100) according to claim 1, wherein an eight-way valve (129) and/or the drive unit (109) and/or a battery unit (107) and/or a drive heat exchanger unit (131) are integrated into the third cooling circuit (105), and wherein the drive unit (109) and/or the battery unit (107) and/or the drive heat exchanger unit (131) can be thermally coupled to the refrigeration circuit (111) as heat sources and/or heat sinks by switching the eight-way valve (129).

6. The cooling system (100) according to claim 5, wherein a first three-way valve (133) is controllably arranged in the third cooling circuit (105) between the eight-way valve (129) and the evaporator unit (115) of the refrigeration circuit (111).

7. The cooling system (100) according to claim 6, wherein a second three-way valve (135) is controllably arranged in the third cooling circuit (105) between the eight-way valve (129) and the condenser unit (113) of the refrigeration circuit (111).

8. The cooling system (100) according to claim 7, wherein the eight-way valve (129), the first three-way valve (133), the second three-way valve (135) and at least one pump unit (123, 127, 139, 141) are integrally realized in a ten-way valve (137).

9. The cooling system (100) according to claim 6, wherein a third pump unit (139) is arranged in the third cooling circuit (105) upstream of the first three-way valve (133) between the eight-way valve (129) and the first three-way valve (133).

10. The cooling system (100) according to claim 5, wherein a fourth pump unit (141) is arranged in the third cooling circuit (105) downstream of the eight-way valve (129) between the eight-way valve (129) and the drive unit (109).

11. The cooling system (100) according to claim 1, wherein the refrigeration circuit (111) is configured as a compact refrigeration system, and wherein the condenser unit (113), the evaporator unit (115), the expansion unit (117) and the compressor unit (119) are installed on a base unit of the compact refrigeration system.

12. The cooling system (100) according to claim 11, wherein there is a pipeless fluidic connection between the condenser unit (113) and/or the evaporator unit (115) and/or the expansion unit (117) and/or the compressor unit (119) of the compact refrigeration system.

13. The cooling system (100) according to claim 1, wherein the refrigeration circuit (111) is filled with a combustible refrigerant.

14. A method (200) for tempering a passenger cabin and/or a drive unit (109) and/or a battery unit (107) of a vehicle via a cooling system (100) according to claim 1, comprising:
activating (201) a cooling mode of the passenger cabin by switching a first pump unit (123) and activating the first cooling circuit (101) and activating the third cooling circuit (105) while simultaneously deactivating the second cooling circuit (103); and/or
activating (203) a heating mode of the passenger cabin by switching a second pump unit (127) and activating the second cooling circuit (103) and activating the third cooling circuit (105) while simultaneously deactivating the first cooling circuit (101); and/or
activating (205) a dehumidification mode of the passenger cabin by switching the first pump unit (123) and activating the first cooling circuit (101) and switching the second pump unit (127) and activating the second cooling circuit (103).

15. A ten-way valve (137) for a cooling system (100) for a vehicle according to claim 1.
